(19) United States
(12) Patent Application Publication
(10) Pub. No.: US 2010/0283753 A1
(43) Pub. Date: Nov. 11, 2010

(54) INPUT PROCESSING DEVICE

(75) Inventor: Kazuhito OHSHITA, Fukushima-ken (JP)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: ALPS ELECTRIC CO., LTD., Tokyo (JP)

(21) Appl. No.: 12/771,394

(22) Filed: Apr. 30, 2010

(30) Foreign Application Priority Data
May 8, 2009 (JP) 2009-113696

(51) Int. Cl. G06F 3/048; G06F 3/041

(52) U.S. Cl. 345/173; 715/784

(57) ABSTRACT

An input processing device an embodiment of the present invention includes an input pad having an input face; a detection unit configured to detect an indicator touched on the input face; and a control unit configured to display content on a display device based on an input signal obtained from the detection unit. Herein, the control unit includes a processing unit configured to scroll the display content based on an input signal; and a determination unit configured to detect the movement speed of the indicator so as to be compared with a preset threshold value for determination. The processing unit has a first operation processing module and a second operation processing module for scrolling the display content. The display content is scrolled using one of the first operation processing module and the second operation processing module, based on a determination result from the determination unit.

### CROSS REFERENCE TO RELATED APPLICATION

The present invention contains subject matter related to and claims priority to Japanese Patent Application JP 2009-113696 filed in the Japanese Patent Office on May 8,2009, the entire contents of which is incorporated herein by reference.

### BACKGROUND OF THE DISCLOSURE

1. Technical Field

The present disclosure relates to an input processing device mounted in an electronic device such as a computer or the like, and more particularly, to an input processing device having a scroll function.

2. Related Art

In an electronic device such as a computer or the like, a scroll operation is frequently performed which displays new content which cannot be displayed entirely, by moving display content such as character information, image information or the like displayed on a display screen in any direction.

A touch pad has been used as one means for performing this scroll operation, and, a mobile phone has been known which has a function of scrolling display content by use of a touch pad (for example, refer to Japanese Unexamined Patent Application Publication No. 2007-66031 as a related art).

In the related art, a continuous working region (scroll region), in which the cursor is kept moving even when a sliding operation of a finger is stopped, is set in a lower end portion of the touch pad, and thereby the display content on the display screen is scrolled while the finger is touching on the continuous working region.

However, refer to Japanese Unexamined Patent Application Publication No. 2007-66031, the ratio of the movement amount of the sliding operation by the finger on the touch pad and the movement amount of the cursor displayed on a display device is set in advance by a user, and the scroll is made not by page unit but by row unit.

For this reason, for example, when the operator intends to move to a target page by skipping several pages, as in a movement from a first page to a last page, the scroll region is required to be continuously pressed until the target page appears, and therefore significant operation time is forced on the operator.

In addition, for example, even when both a scroll function by row unit and a scroll function by page unit are provided, the scroll by row unit and the scroll by page unit are not changed smoothly by a simple operation and thus the scroll operation cannot be performed efficiently.

These and other drawbacks exits.

### SUMMARY OF THE DISCLOSURE

It is desirable to provide an input processing device enabling a scroll by row unit and a scroll by page unit to be changed smoothly by a simple operation.

According to an embodiment, an input processing device includes an input pad having an input face; a detection unit configured to detect an indicator touched on the input face; and a control unit configured to display content on a display device based on an input signal obtained from the detection unit. Herein, the control unit includes a processing unit configured to scroll the display content based on an input signal; and a determination unit configured to detect a movement speed of the indicator so as to be compared with a preset threshold value for determination. In addition, the processing unit has a first operation processing module and a second operation processing module for scrolling the display content, and the display content is scrolled by use of one of the first operation processing module and the second operation processing module, based on a determination result from the determination unit.

According to an embodiment, another scroll operation may be selected in response to an operation of a finger. Thereby, a scroll operation can be made smoothly and with greater efficiency.

In the above description, the input face is provided with a scroll region, and when an operation from the indicator is provided to the scroll region, the display content is preferably scrolled.

In the above, it is possible to easily detect that an operation provided by an operator is a scroll.

Also, the input face may be provided with a scroll region, and when an operation from the indicator is provided to any place of the input face, a scroll may be performed using the first operation processing module, and when an operation from the indicator is provided to only the scroll region, a scroll may be performed using the second operation processing module.

In the above means, it is possible to clearly discriminate whether the operation given by the operator is a scroll based on the first operation processing module or a scroll based on the second operation processing module.

Further, when the detection result from the determination unit is “low speed,” the display content may be scrolled using the first operation processing module, and when the detection result is “high speed” or a finger is touched on the scroll region to be slightly brushed, the display content may be scrolled using the second operation processing module.

As described above, the operation processing of the scroll can be selected in response to the operation given by the operator, and thus it is possible to provide a more easily used scroll function by reducing a burden given to the operator.

For example, the first operation processing module may be a scroll by row unit, and the second operation processing module may be a scroll by page unit.

In addition, the processing unit may be activated by software stored in a control unit of a personal computer, and the determination unit may be activated by software included in the processing unit. According to the various embodiments, the scroll by row unit and the scroll by page unit can be changed by a simple operation, for example, by a touch operation such as slight brushing of a finger. Thereby, the scroll operation can be made efficiently.

### BRIEF DESCRIPTION OF THE DRAWINGS

FIG. 1 is a perspective view illustrating a note book type personal computer (PC) which mounts an input processing device according to an embodiment of the disclosure;

FIG. 2 is a plan view of a planar input processing device;

FIG. 3 is a circuit block diagram of the input processing device;

FIG. 4 is a flowchart illustrating an operation processing of the input processing device according to an embodiment of the disclosure; and

FIG. 5 is a flowchart illustrating an operation processing of a scroll detection routine arranged in the flowchart shown in FIG. 4.

### DESCRIPTION OF EXEMPLARY EMBODIMENTS

The following description is intended to convey a thorough understanding of the embodiments described by providing a number of specific embodiments and details involving input processing devices. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

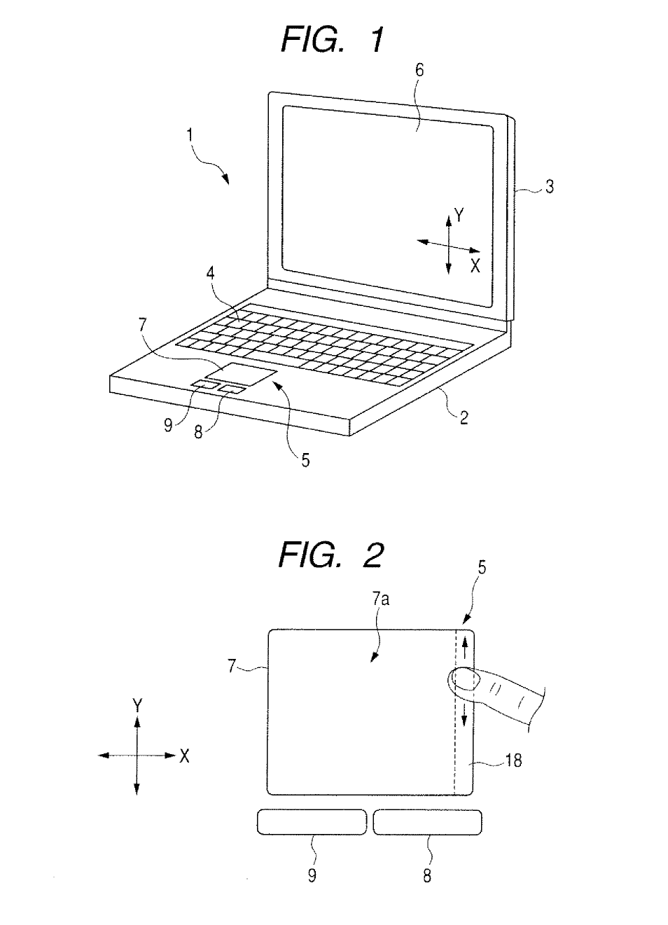

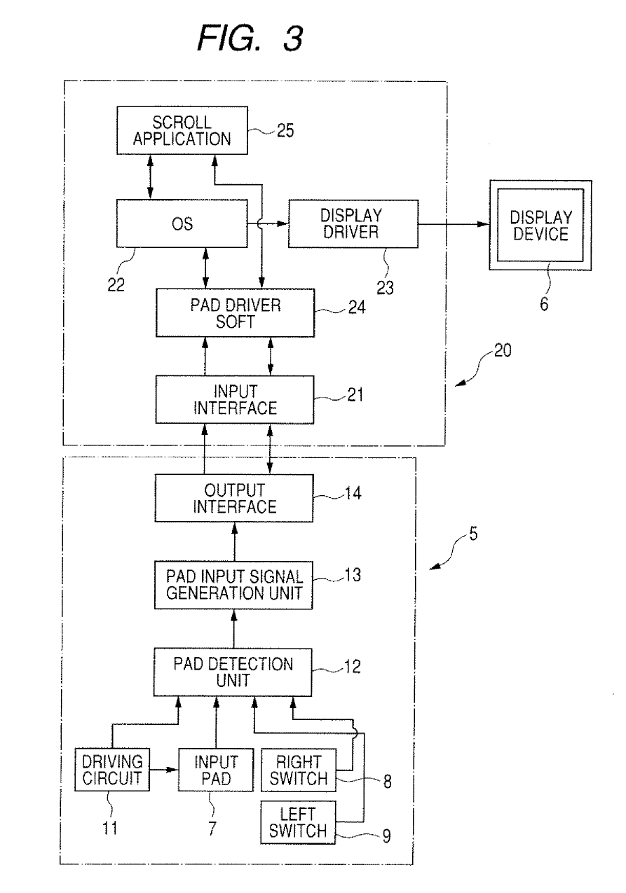

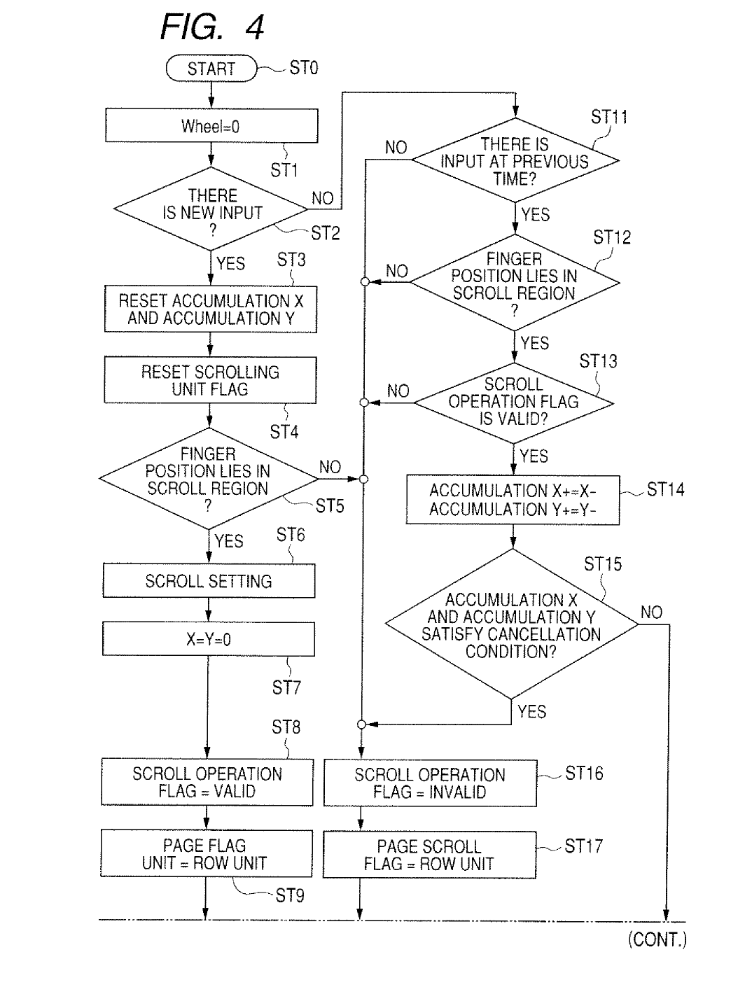

FIG. 1 is a perspective view illustrating a note book type personal computer (PC) which has mounted an input processing device according to an embodiment of disclosure, FIG. 2 is a plan view of a planar input processing device, and FIG. 3 is a circuit block diagram of the input processing device.

In a personal computer 1 shown in FIG. 1, a body part 2 may be covered by a cover part 3 so as to be folded small and be connected to each other. A keyboard device 4 and a planar input processing device 5 may be provided on a control panel of a surface of the body part 2. A display device 6 formed of a liquid crystal display panel, for example, may be provided on a front side of the cover part 3.

As enlarged in FIG. 2, the planar input processing device 5 may have an input pad (touch pad) 7, a right button 8 placed in a bottom right thereof and a left button 9 placed in a bottom left thereof. In addition, the right button 8 and the left button 9 may not be indispensable parts in constituting the input processing device 5 according to an embodiment of the disclosure.

The input pad 7 may include an input face 7a which may be even. In the input pad 7, a plurality of X electrodes extending in the X direction and a plurality of Y electrodes extending in the Y direction may be disposed opposite to each other interposing an insulating layer therebetween, and each of detection electrodes may be provided between the adjacent X electrodes. A thin insulating sheet may be provided on a surface of these electrodes, and a surface of the insulating sheet may correspond to the input face 7a.

As shown in FIG. 3, a driving circuit 11 provided in the input processing device 5 may sequentially apply predetermined voltages to the X electrodes and also may sequentially apply predetermined voltages to the Y electrodes at the timing different therefrom. When a finger, which is a conductive indicator having almost a ground voltage, is touched on the input face 7a, a capacitance may be generated between the finger and each of the electrodes, and thereby the capacitance between the detection electrode and the X electrode may vary in the portion where the finger approaches and the capacitance between the detection electrode and the Y electrode also varies.

This variation of the capacitance enables a voltage rising time in a pulse applied to the X electrode or the Y electrode to be delayed. This delay of the voltage rising time at this time may be detected by a pad detection unit 12 via the detection electrode. When the pad detection unit 12 detects the delay of the voltage rising from the detection electrode, it may be possible to detect a place where the finger is touched on the X-Y coordinate, by obtaining timing information concerning which X electrode or Y electrode is applied with a voltage at that time.

Therefore, when the finger making contact to the input face 7a moves, a movement trace of the finger can be detected on the X-Y coordinate. In addition, when a so-called tap operation is performed that a finger quickly moves near and quickly moves away from the input face 7a, the capacitance between the electrodes may vary for a short time, and thus this can be detected by the pad detection unit 12.

As shown in FIG. 2, the input face 7a may have a plurality of regions divided in advance in the input pad 7, and each kind of operation function is allocated to its own the regions. The method for setting the number of divided regions or the size of the area of each region or what kind of function is allocated to each region, can be set and changed by operating a setting menu of a pad driver software 24 described later. In the embodiment shown in FIG. 2, a scroll region 18 with a stripe shape may be placed in the rightmost of the input face 7a. In addition, the position of the scroll region 18 may not be limited to the rightmost of the input face 7a but can be freely set by selection of an operator. Generally, when the scroll is made in the longitudinal direction (the Y direction in FIG. 1) on the display screen, the scroll region 18 may be placed in the rightmost or the leftmost, and when the scroll is made in the transverse direction (the X direction in FIG. 1), the scroll region 18 may be placed in the uppermost or the lowermost.

The planar input processing device 5 shown in FIG. 3, as described above, has the driving circuit 11 which may sequentially apply pulsed voltages to the X electrodes and the Y electrodes of the above-described input pad 7 and the pad detection unit 12 which may detect a variation in the voltage rising in the detection electrode provided in the input pad 7. The contact position of a finger on the input face 7a can be specified on the X-Y coordinate by the pad detection unit 12. Operation signals of the right button 8 and the left button 9 may be detected by the pad detection unit 12 as well.

A pad input signal generation unit 13 may be provided in the input processing device 5. In the pad input signal generation unit 13, X-Y coordinate information which may be an operation signal of the input pad 7 detected by the pad detection unit 12, and switch input information of the right button 8 and switch input information of the left button 9 may be converted into data of a format having a predetermined number of bytes and output from an output interface 14. The operation signals output from the output interface 14 may be sent to an input interface 21 provided in a control unit 20 of the personal computer. The output interface 14 and the input interface 21 may include a USB interface and/or other like interfaces.

Various kinds of software may be stored in the control unit 20 of the personal computer 1. The control unit 20 may store an operating system (OS) 22. A display driver 23 may be controlled by this operating system 22 to display various kinds of information on the display device 6.

The pad driver software 24 may be installed in the control unit 20, and the operation signals received via the input interface 21 may be sent to the pad driver software 24. The pad driver software 24 may generate a coordinate data signal or the like, based on the operation signal with a predetermined format sent from the pad input signal generation unit 13, and may notify the operating system 22.

Also, a scroll application software 25 which may function as a processing part may be provided in the control unit 20.

The scroll application software 25 may be for selecting a row unit scroll and a page unit scroll, may determine to which one of the row unit scroll and the page unit scroll an operation by an operator corresponds based on the coordinate data signal and may notify the operating system 22 of the determination information.

An operation of the input processing device will now be described.

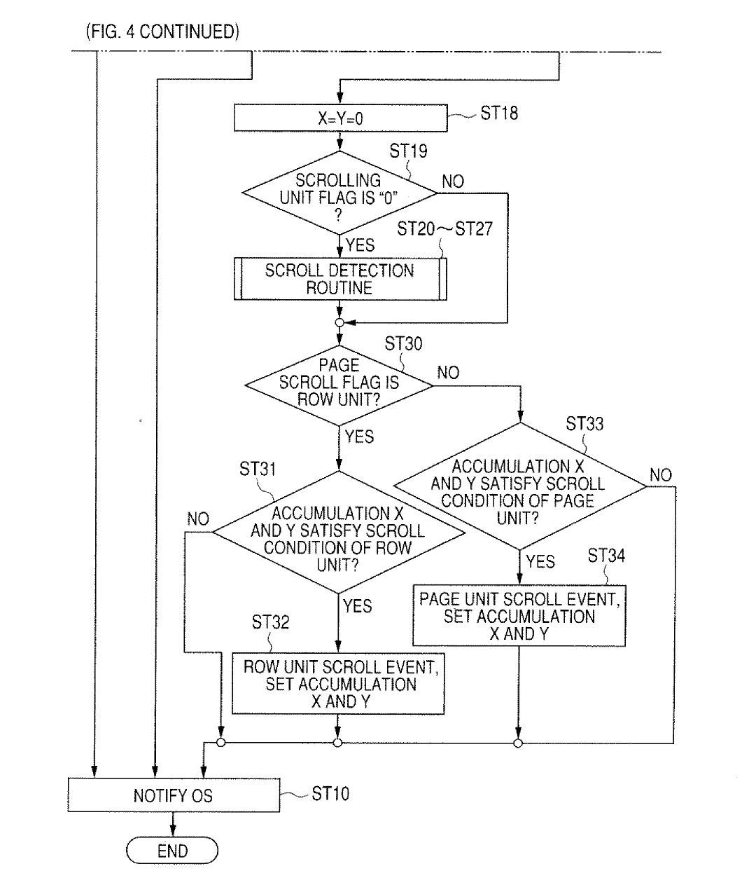

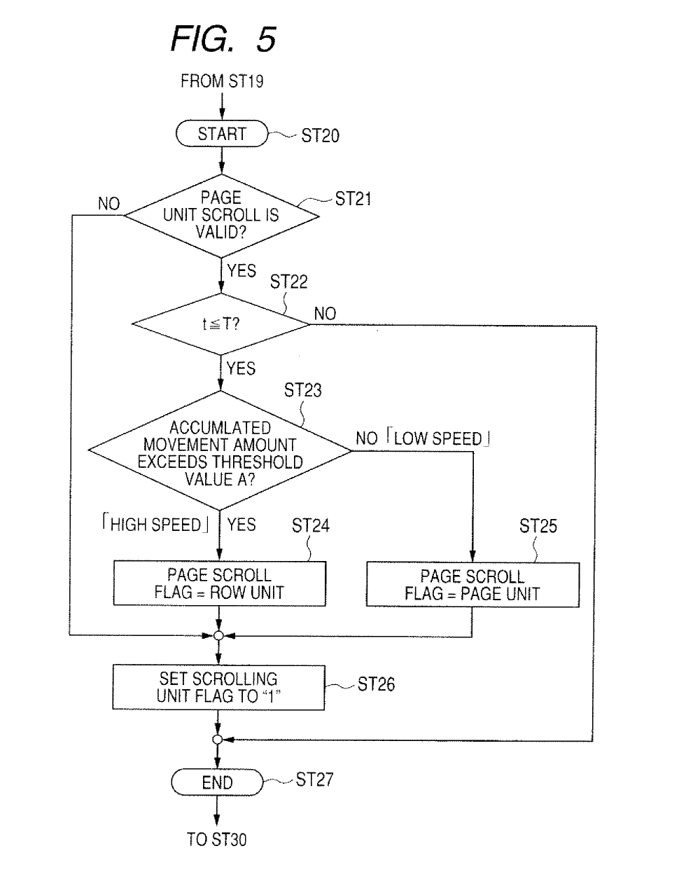

FIG. 4 is a flowchart illustrating an operation processing of the input processing device according to various embodiments of the disclosure, and FIG. 5 is a flowchart illustrating an operation processing of a scroll detection routine arranged in the flowchart shown in FIG. 4. In addition, in the following description, each step of the operation processings is denoted by “ST.”

In the control unit 20, the operating system (OS) 22 controls the pad driver software 24 and the scroll application software 25 and monitors may coordinate data signals by polling at a predetermined time interval, for example.

As shown in FIG. 4, when a coordinate data signal is input, the scroll application software 25 may start the operation processing (ST0), the wheel may be set as Wheel=0 at ST1. The Wheel refers to a wheel operation in a mouse function, and a scroll of the screen may be made by rotating the wheel. When the wheel operation is performed, this may set Wheel=1, for example, and when the wheel operation is not performed, this may set Wheel=0, for example. The wheel operation may not be accompanied in the various embodiments, and thus Wheel=0 may set in such an embodiment.

Subsequently, it may be checked whether a new input is detected with respect to the input face 7a of the input pad 7 at the time of the latest polling (ST2). If the new input is detected (y), the process may go to ST3, and if the new input is not detected (n), the process may go to S11.

At ST3, values in an accumulation X buffer and an accumulation Y buffer may be reset. The values stored in the accumulation X buffer and the accumulation Y buffer may be accumulation values in the X direction and the Y direction concerning the movement amount of a finger which may move on the input face 7a.

When the finger is detected to be touched on the input face 7a in the middle of the operation processing, the pad driver software 24, as described later, may calculate an accumulated movement amount of the finger for each of the X direction and the Y direction and may update the contents of the accumulation X buffer and the accumulation Y buffer.

At ST4, a scrolling unit flag may be reset (set to 0). In addition, the scrolling unit flag may be a flag for determination needed for executing a scroll detection routine (ST20 to ST27) at ST19 described later.

Next, at STS, it maybe checked whether or not the position where the finger is touched lies in the scroll region 18. This check is performed based on the coordinate data signal. At this time, if the position touched by the finger lies in the scroll region 18 (y), the process goes to ST6, and, if not (n), the process goes to ST16.

At ST6, a scroll setting may be made due to cancellation of each value. For example, a position in the coordinate on the input face 7a where the finger is currently being touched may be set to X=0 and Y=0 at ST7, a scroll operation flag may be set to “valid” at ST8, and a page scroll flag is set to a “row unit” at ST9.

Further, the scroll operation flag may be set to “valid” or “invalid.” In such embodiments, “valid” may refer to a state capable of performing a scroll processing and “invalid” may refer to a state of not performing the scroll processing. In addition, the page scroll flag may be set to a “row unit” or a “page unit, ” and the “row unit” may refer to a scroll operation processing carried out by row unit (first operation processing) and the “page unit” may refer to a scroll operation processing carried out by page unit (second operation processing).

When the scroll setting is completed, notification of the plural pieces of information regarding the setting states of the respective flags, the X and Y values for the touched position the setting state of the Wheel and so on are may be sent to the operating system 22 (ST10), and the operation processing by the scroll application software 25 may be finished.

If the position touched by the finger is out of the scroll region 18 at ST5 (n) , the scroll operation flag may be set to “invalid” at ST16, and the page scroll flag may be formally set to a “row unit” at ST17, and the operating system 22 may be notified of these setting contents at ST10. In this case, since the scroll operation flag is “invalid,” the scroll processing may not be performed on the display device.

When the new input is not detected at the latest polling at ST2 (n), the process may go to ST11. At ST11, although the new input is not detected at the latest polling, it may be checked whether or not an input has been detected at the time of a previous polling. If the input has been detected at the time of the previous polling (y), the process may go to ST12, and if the input has not been detected (n), the process may go to ST16. At ST12, it may be checked whether or not the position touched by the finger at the time of the previous input lies in the scroll region 18 at ST11, if it is checked to lie in the scroll region 18 (y), the process may go to the ST13, and if it is checked to be out of the scroll region 18 (n), the process may go to ST16. The scroll operation flag may be checked at ST13, and if it is checked to be set to “valid” (y), the process may go to ST14. If it is checked to be set to “invalid” which is not valid (n), the process may go to ST16.

At ST14, when the scroll operation flag is set to “valid,” the movement amount in the X direction and the movement amount in the Y direction concerning the position touched by the finger detected at the time of the previous polling may be added to the accumulation X buffer and the accumulation Y buffer and thereby the contents thereof are updated.

At next ST15, it maybe checked whether or not each value stored in the accumulation X buffer and the accumulation Y buffer satisfies the cancellation condition of the scroll, and if it satisfies the condition (y) , the process may go to ST16, and if it does not satisfy the condition (n) , the process may go below the steps including ST18.

Here, cancellation condition of the scroll is not satisfied refers to, for example, when the added amounts (accumulated values) of the movement amounts in the X direction and Y direction do not exceed a predetermined amount. Further, when the touching time of a finger does not reach a predetermined time, it may be determined as the cancellation condition of the scroll being not satisfied.

When the results are n at ST11, ST12 and ST13 and the result is y at ST15, the process may go to ST16, and the scroll operation flag may be set to “invalid” at ST16 and the page scroll flag may be set to a “row unit” at ST17, respectively. Thereafter, the process may go to ST10 so that notification of the plural pieces of information regarding the setting states of the respective flags, the X and Y values for the touched position, the setting state of the Wheel and so on may be sent to the operating system 22.

If the cancellation condition of the scroll is not satisfied at ST15, the process may go to ST18, and a coordinate of the position touched by the finger placed on the input face 7a may be set to X=0 and Y=0 at ST18. In addition, at this time, a measurement also may be initiated by the timer.

At ST19, it may be checked to which one of “0” and “1” the scrolling unit flag is set. If the scrolling unit flag is set to “0” (y), the process may go to the scroll detection routine at ST20 to ST27, and if the scrolling unit flag is set to “1” (n) , the process may go below the steps including ST30.

The scroll detection routine at ST20 to ST27 shown in FIG. 5 functions as a determination part which may detect a movement speed is high or low, based on the movement amount of a finger detected within a designation time T, and may determine whether a scroll by row unit is made or a scroll by page unit is made based on the detection result.

At ST21, it may be checked whether or not the scroll by page unit is set to “valid.” If set to “valid” (y), the process may go to ST22, and if set to “invalid” (n), the process may go to ST26 so as to skip this scroll detection routine (ST27) and go below the steps including ST30.

At ST22, it may be checked whether or not an elapsed time t since the timer initiates the measurement at ST18, that is, an elapsed time t since the finger is touched on the input face 7a, exceeds a predetermined designation time T. If the elapsed time t lies in the designation time T (y) (in case of t≦T), the process may go to ST23 so as to determine a movement speed. On the other hand, if the elapsed time t exceeds the designation time T (n), the process may go below the steps including ST 30 so as to skip the scroll detection routine (ST27) without the determination of the movement speed.

Further, the designation time T can be freely set or changed from the setting menu of the scroll application software by an operator.

At ST23, the accumulated movement amount of the finger may be compared with a predetermined threshold value A. If the accumulated movement amount of the finger is larger than the predetermined threshold value A (y), the movement speed of the finger is determined to be “high,” and the process then may go to ST24 so as to set the page scroll flag to a “row unit” and to go to ST26. In contrast, if the accumulated movement amount of the finger is smaller than the predetermined threshold value A (n), the movement speed of the finger is determined to be “low,” and the process then may go to ST 25 so as to set the page scroll flag to a “page unit” and to go to ST26. The accumulated movement amount of the finger may correspond, for example, to a square root of the sum of a square of a value stored in the accumulation X buffer and a square of a value stored in the accumulation Y buffer.

The threshold value A can be freely set or changed from the setting menu of the scroll application software by an operator.

The scrolling unit flag is set to “1” at ST26, and the scroll detection routine may be skipped (ST27), and the process may go below the steps including ST30.

As shown in FIG. 4, the page scroll flag may be checked at ST30, and when the “row unit” is set (y), the process may go to ST31. Otherwise (n), that is, when the “page unit” is set, the process may go to ST33.

At ST31, it may be checked whether or not each value in the accumulation X buffer and the accumulation Y buffer satisfies the scroll condition by row unit.

If satisfying the condition (y), the process may go to ST32 so that the scroll by row unit is set to an event presence and the accumulation X buffer and the accumulation Y buffer are reset, and then the process may go to ST10. In addition, if not satisfying the condition (n), the process may go to ST10 as it is.

At ST33, it may be checked whether or not each value in the accumulation X buffer and the accumulation Y buffer satisfies the scroll condition by page unit.

If satisfying the condition (y), the process may go to ST34 so that the scroll by page unit may be set to an event presence and the accumulation X buffer and the accumulation Y buffer are reset, and then the process may go to ST10. In addition, if not satisfying the condition (n), the process may go to ST10 as it is.

At ST10, notification of the plural pieces of information regarding the setting states of the respective flags, the X and Y values for the touched position, the setting state of the Wheel and so on may be sent to the operating system 22, and the operation processing by the scroll application software 25 may be finished.

When the operating system 22 is notified of the “row unit” as the page scroll flag from the scroll application software 25 (in case of ST9 and ST32), the display driver may be set to an operation processing for scroll in the “row unit,” and when it is notified of the “page unit” (in case of ST34) , the display driver may be set to an operation processing for scroll in the “page unit.” Based on these settings, the display driver 23 may scroll display content such as character information or image information or the like displayed on the display device 6 by row unit or by page unit, according to the movement amount or the moving direction of the finger.

For example, when the finger moves downwardly, the content may be scrolled to rear rows in the row unit or may be scrolled to rear pages in the page unit. In addition, when the finger moves upwardly, the content may be scrolled to front rows in the row unit or is scrolled to front pages in the page unit.

As above, when the accumulated movement amount of the finger which moves within the predetermine designation time T exceeds the predetermined threshold value A, the scroll may be set to the “row unit,” and when the accumulated movement amount of the finger which moves within the predetermine designation time T does not exceed the predetermined threshold value A, the scroll may be set to the “page unit.” Thereby, the scroll can be set to the row unit or the page unit by a simple operation such as the movement speed change of the finger. In addition, even when other scrolls are selected, the operation of the finger may be performed with respect to the same scroll region 18 and thus the scroll by row unit and the scroll by page unit can be changed smoothly. For this reason, it may be possible to perform the scroll operation and the change operation with good efficiency.

As an element for detecting the scroll by row unit and the scroll by page unit in addition to the movement amount described above, a touched area between the finger and the input face 7a may be used. The touched area between the finger and the input face 7a can be calculated based on the coordinate data signal. For example, when the detected touched area exceeds a predetermined threshold area, it may be detected as a scroll by page unit, and when the touched area does not exceed the predetermined threshold area, it may be detected as a scroll by row unit. Thereby, in the same manner as the above description, the scroll can be set to the row unit or the page unit.

When the scroll is set to the row unit or the page unit, the setting method based on the touched area may be added to the setting method based on the movement amount described above.

In this case, the determination for the scroll by row unit and the scroll by page unit can be made based on a different reference, and therefore it may be possible to increase detection accuracy as to whether an operation by an operator is intended as a scroll by row unit or a scroll by page unit.

In the above description, although the case where the detection of the scroll by row unit and the scroll by page unit is made in the same scroll region 18 has been described, the present invention is not limited to this. For example, a configuration is possible in which a detection of the scroll by row unit is made in the entire region of the input face 7a and a detection of the scroll by page unit is made only in the scroll region 18. In addition, a configuration reverse thereto is possible.

A scroll region for the scroll by row unit and a scroll region for the scroll by page unit may be set separately, and the detection may be made at each scroll region. In this case where the scroll regions are separated, it may be possible to reliably detect whether an operation by an operator is intended as the scroll by row unit or the scroll by page unit.

It should be understood by those skilled in the art that various modifications, combinations, sub-combinations and alterations may occur depending on design requirements and other factors insofar as they are within the scope of the appended claims of the equivalents thereof. Accordingly, the embodiments of the present inventions are not to be limited in scope by the specific embodiments described herein. Further, although some of the embodiments of the present invention have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. An input processing device comprising:
an input pad having an input face;
a detection unit configured to detect an indicator touched on the input face; and
a control unit configured to display a display content on a display device based on an input signal obtained from the detection unit,
wherein the control unit includes a processing unit configured to scroll the display content based on an input signal; and a determination unit configured to detect a movement speed of the indicator so as to be compared with a preset threshold value for determination,
wherein the processing unit has a first operation processing module and a second operation processing module for scrolling the display content, and
wherein the display content is scrolled using one of the first operation processing module and the second operation processing module, based on a determination result from the determination unit.

2. The input processing device according to claim 1, wherein the input face is provided with a scroll region, and when an operation from the indicator is provided to the scroll region, the display content is scrolled.

3. The input processing device according to claim 1, wherein the input face is provided with a scroll region, and when an operation from the indicator is provided to any place on the input face, a scroll is performed using the first operation processing module, and when an operation from the indicator is provided to only the scroll region, a scroll is performed using the second operation processing module.

4. The input processing device according to claim 1, wherein when the detection result from the determination unit is low speed, the display content is scrolled using the first operation processing module, and when the detection result is high speed, the display content is scrolled using the second operation processing module.

5. The input processing device according to claim 1, wherein the first operation processing module is a scroll by row unit, and the second operation processing module is a scroll by page unit.

6. The input processing device according to claim 1, wherein the processing unit is activated by software stored in a control unit of a personal computer, and the determination unit is activated by software included in the processing unit.
